(19) United States
(12) Patent Application Publication
(10) Pub. No.: US 2008/0034531 A1
(43) Pub. Date: Feb. 14, 2008

(54) Vibrating wiper blade

(76) Inventor: Bennie Max Beaver, West Valley, UT (US)

Correspondence Address: Bennie M. Beaver, 4571 S 3600 W, Salt Lake, UT, 84119, US

(21) Appl. No.: 11/501,016

(22) Filed: Aug. 9, 2006

(51) Int. Cl. B60S 1/38

(52) U.S. Cl. 15/250.361; 15/250.44; 15/250.001

(57) ABSTRACT

A vibrating wiper blade that is functional and attractive. A standard wiper blade can be engineered to accommodate vibrating motors in a sleek and decorative design. Attached to the wiper blades and vibrating motors are tailor made and smoothly attached and designed electrical wiring. The vibrating motors may be engineered on wiper blades from the manufacturing stage, or provide at outlet stores and travel plazas as clip-on models with wiring attached under the hood, and/or controls quickly extended through a driver window. The vibrating motors will facilitate the removal of ice and snow from windshield wiper blades while avoiding hopping and skipping on the windshield. Tailor engineered models may be designed with a direct vibrating spring loaded pin or pistion to strike the wiper blade head. All of this is designed at minimal cost and complexity.

### FIELD OF THE INVENTION

The present invention relates to winter designed windshield wiper blades and, more particularly, improves the removal of winter time ice and snow from wiper blades and windsheilds.

### BACKGROUND OF THE INVENTION

Ever since windows and windshields on mobile vehicles (e.g., especially, cars, truck, and off road vehicles) were invented, there has been a need to keep them clear of dirt, grime and, particularly, ice and snow. A simple and low cost solution has been pondered from the earlierest days.

While cleaning windows and windshields on carriages was initially of concern, as technology advanced, more sophisticated vehicles such as cars and trucks became uniquely important. In fact, due to the high speed, vicissitudes of transportation across meteorological space, and the congestion of modern life, the needs for clean and clear windows has increased enormously. Having driven large off the road, and over the road vehicles and trucks, I have personally experienced the problems of removing ice and snow from windshields in the midst of an ice and snow blizzards. It is not unusual to discover trucks and cars stopped, precariously, on the side of roads and freeways to clear wiper blades and windshields of ice and snow. In spite of today winter designed wiper blades little seems to have changed for the better.

The probability of today designed winter wiper blades comprehensibly preventing the build up of ice and snow on, especially, large over the road truck windshields, has not been apparent to me or most truckers that I have talk to. There is a need for an added component invention.

Finally, from personal experience, I can say that driving a large truck in blizzard conditions can be extremely dangerous. I have yet to witness large numbers of over the road, or other vehicles, using presently available winter wiper blades. While presently available wiper blades can be helpful for keeping windsheilds clear of ice and snow, there is still a need for added improvements.

Several designed winter windshield wiper systems have been invented to remove ice and snow from stationary and, particularly, mobile vehicles. Many of those systems may be purchased from retailers on the Internet or brick and mortar stores. For example, United states patent applications numbers: 20030057197 issued to SCHMIDT, William P. for a WINDSHIELD WIPER HEATER system; 20040134995 issued to KEELER, RUSSELL M. for a VEHICLE WINDSHIELD ICE AND SNOW MELT SYSTEM; 20040128787 for a WINDSHIELD WIPER BLADE SLAPPER APPARATUS; 20050086758 issued to ARKASHEVSHI, URI; ET AL. for a SYSTEM AND METHOD FOR CLEANING OR DE-ICING A WINDSHIELD, or the like.

All of the afore mentioned windsheld wiper ice and snow removal systems have advantages and disavantages in effectiveness and cost constrains. although I have heard more about those types of systems than I have actually seen installed on any vehicles, I can best witness to my years of over the road truck driving. I have never seen any of those systems on any over the road trucks, personally. I can attest to having conversed with other drivers over the effectiveness of some of those system, and the affirmations have always been mediocre. While some drivers may affirm some real benefits, always straggled with reservations, I can yet say that no final or comprehensive solution has been invented.

I have driven many times over one of the coldest stretches of American freeways—Wyoming I-80. More than once I, and other truckers, have been caught in the midst of a blizzard on I-80 and have had to reach out the driver window and slap the wiper blade against the window or strike the wiper with a stick to remove ice and snow. Slapping or striking the wiper blade will damage it much sooner than either low heat or vibration. The fact is that slapping or striking a wiper blade still does not remove all of the ice and snow in a very imposing blizzards. My vibrator wiper blade may eliminate the need to slap or strike the wiper blade. Also, my virbrator wiper blade will reduce the need to expend as much heating energy to accomplish as good or better result.

Morevover, no current approach to the problem of ice and snow removal has yet imagined a solution by way of vibrational frequencies at the very molecular stage of ice and snow formation. In addition, my virbrational wiper blade provides direct impact and jarring to facilitate the removal of ice and snow before it has time to solidify. A combination of methodologies will best solve the problem of removal of ice and snow from windshield wiper blades. My vibrating wiper blade is an invention that does the job at a cost less than one might imagine. Vibrating motors for my wiper blade are available so small that they will not hinder driver vision, nor will they hop and skip in any way; as I have demonstrated with my first rough model already constructed and tested.

It is an object of the invention to provide vibrational energy for facilitating the removal of ice and snow from winter time windshield wiper blades.

It is also the object of the invention to provide direct impact to the wiper blades, thereby, facilitating the removal of ice and snow.

It is an object of the invention to make a minimal sound to drivers of all vehicles.

It is an object of the invention to accomplish the objectives without hopping or skipping.

It is an object of the invention to contribute a valueable and useful function in the removal of ice and snow from windshield wiper blades.

### SUMMARY OF THE INVENTION

In accordance with the present invention, there is provided a vibrating wiper blade that is functional and attractive. A standard wiper blade can be engineered to accommodate vibrating motors in a sleek and decorative design. Attached to the wiper blades and vibrating motors are tailor made and smoothly attached and designed electrical wiring. The vibrating motors may be engineered on wiper blades from the manufacturing stage, or provide at outlet stores and travel plazas as clip-on models with wiring attached under the hood, and/or controls quickly extended through a driver window. The vibrating motors will facilitate the removal of ice and snow from windshield wiper blades while avoiding hopping and skipping on the windshield. Tailor engineered models may be designed with a direct vibrating spring loaded pin or pistion to strike the wiper blade head. All of this is designed at minimal cost and complexity. The vibrating wiper blade can be designed to be aesthetically pleasing with little obstruction to vision.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a vibrating wiper blade test model completely modifying another invented application in accordance with the invention; and

FIG. 2 is a front drawing perspective view of a vibrating wiper blade in accordance with the invention.

For purposes of clarity and brevity, like elements and components will bear the same designations and numbering throughout the Figures.

### DESCRIPTION OF THE PREFERRED EMBODIMENT

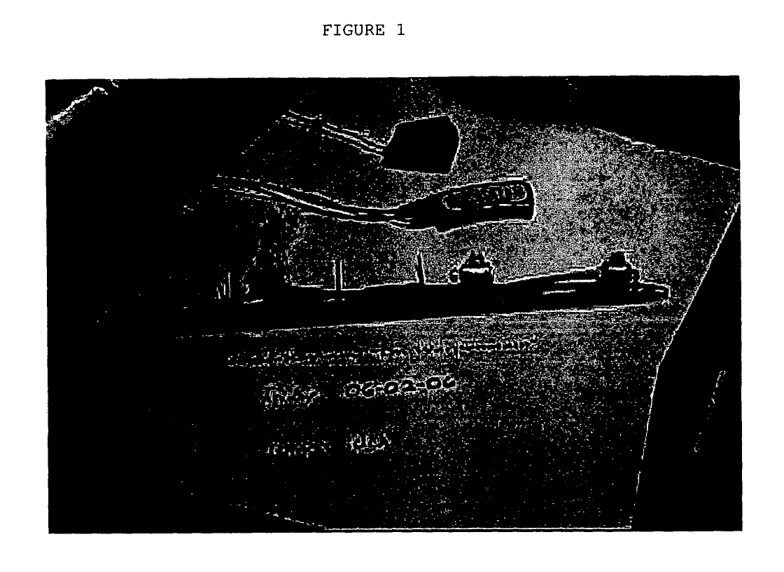

FIG. 1 is a perspective view of a vibrating wiper blade test model completely modifying another invented application in accordance with the invention. The model in the photograph was created when the inventor, experiencing an epiphany, realizing that the elements of another, and completely different invention, possessed most of the elements of the invention. The other invention, used to create the test model is a DR. SCHOLL'S vibrator seat cushion appliance Model DR8553-TYPE NSM8553EA-Copyright 2004 Schering-Plough/HealthCare Products, Inc.

The test model was operated and witnessed by several individuals including a mechanical engineer. All witnesses were appropriatedly impressed with the test model and its operations functionality.

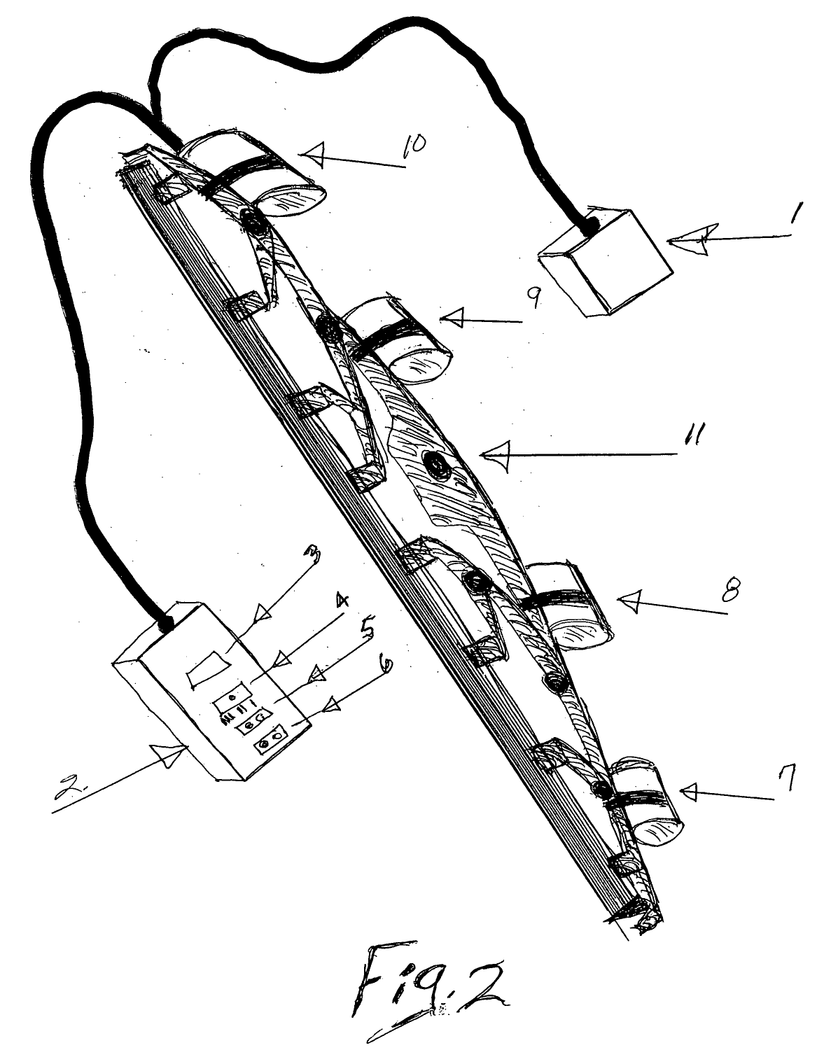

FIG. 2 is a drawing, perspective view of the vibrating wiper blade in accordance with the invention.

FIG. 1 is a photo copy of a preliminary test model design.

FIG. 2 is a drawing perspective view of the vibrating wiper blade, in accordance with the invention. Four very small vibrator motors 7, 8, 9, 10, are positioned along the top of a standardized wiper blade 11. In this particular test model the vibrator motors are powered by 1, HON-KWANG plug in class 2 transformer-MODEL NO: A12-1A-INPUT: 120V/60 Hz 18W-OUTPUT: 12VAC 1000 mA. Moreover, the power may be supplied by AC or DC source. The number, shape, size, power, and design configuration of the vibrator motors may be determined by the end use and cost relative to aesthetics, driver vision, and the engineering constrains. The test model suggest that the possiblities for differing designs are attainable.

Vibrator motors may be quickly clamped or secured in place by an enumerative specially designed tools, like keyed Allen wrenches. Furthermore, vibrator motors may be particularly engineered on the wiper blades at the first manufacturing process.

Power and control modules 1, 2, wiring may be aesthetically secured along the wiper blade frame. The power wiring is routed down into the front firewall area of a vehicle to be wired directly into the vehicle electrical system, or with clamped on models, to be routed directly into a driver window or through the firewall into the vehicle lighter/power plug. Additionally, the control module 2, may be routed through a driver side window or through the firewall area.

Also, power plug-in module 1, is designed to plug-in directly to DC power or AC power by way of a vehicle converter system. The total vibrator system will work best on a 24 volt systems such as is found on large trucks.

Control module 2, in the test model has four control switches 3, 4, 5, 6, for which 6 turns on a first set of vibrator motors and 5, turns on the second set of motors. Switch 4, will increase the power from one to three power settings. Switch 3, was originally for a heating pad in a seat cushion. In the control system 2, of this presently created wiper blade system, the unused heat switch may be connected to a heating wire for the wiper blade as a preferred combination embodiment of the invention.

The perspective view in drawing FIG. 2 does not represent the relative size difference of motors 7, 8, 9, 10, modules 1, 2, and wiper blade 11.

Thus, in summary, it can be seen that what is provided in this invention is a vibrator wiper blade 11 that is both functional and adaptive. Vibrator motors 7, 8, 9, 10 are adjustable on this test model but may be permanently and aestheticly designed and affixed in place by a manufacturing process. A similar commonly use power and control system may be created for this invention, or negotiated with the manufacture of the DR. SCHOLL seat cushion system. My sudden insight that the DR. SCHOLL'S seat cushion system would perfectly adapt to a completely different invention was exciting and functional. Vibrator motors may be tunable to vibration harmonics facilitating the loosing of ice and snow molecular bonds. The test model works well in its present embodiment. The invention serves a unique functionality for the purpose intented.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A vibrating wiper blade for a vibrating wiper blade for facilitating the removal of ice and snow from windsheilds, comprising:
means for photographed test model; and
means for <purpose>.

2. The vibrating wiper blade in accordance with claim 1, wherein said means for photographed test model comprises a picture test model.

3. The vibrating wiper blade in accordance with claim 1, wherein said means for <purpose> comprises a power supply, control module, wiper blade, vibrators drawing test model.

4. A vibrating wiper blade for a vibrating wiper blade for facilitating the removal of ice and snow from windsheilds, comprising:
a picture test model, for photographed test model; and
a power supply, control module, wiper blade, vibrators drawing test model, for <purpose>.

5. A vibrating wiper blade for a vibrating wiper blade for facilitating the removal of ice and snow from windsheilds, comprising:
a picture test model, for photographed test model; and
a power supply, control module, wiper blade, vibrators drawing test model, for <purpose>.
